(19) United States
(12) Patent Application Publication
(10) Pub. No.: US 2012/0297285 A1
(43) Pub. Date: Nov. 22, 2012

(54) Computer-Implemented Systems And Methods For High Resolution Design Template Generation

(76) Inventors: Brandon Bickford, San Francisco, CA (US); Melissa Kim, San Francisco, CA (US); Niniane Wang, San Francisco, CA (US)

(21) Appl. No.: 13/112,689

(22) Filed: May 20, 2011

(51) Int. Cl. G06F 17/00

(52) U.S. Cl. 715/234

(57) ABSTRACT

Systems and methods are provided for generating a high resolution template in response to user controls provided over a network. An edit to a particular template is received over a network, and a template edit record associated with the particular template is stored in a data store. A preview of the particular template is provided using the network, the preview being an approximation of a high resolution version of the particular template that incorporates the received edit. Additional edits to the particular template are received and stored as additional template edit records. The template edit record and additional template edit records are provided to a high resolution template generator, where the high resolution template generator creates the high resolution version of the particular template based on the template edit record and additional template edit records.

### FIELD

The technology described herein relates generally to graphics design and more specifically to bandwidth considerate design editing.

### BACKGROUND

Traditional providers of graphic design products (e.g., greeting cards, business cards, flyers, brochures) offer a limited number of designs generated by in-house creators or paid third-party contractors. Limited customizations may be available for these design products, such as the incorporation of a corporate logo onto business cards or the inclusion of a photograph onto a greeting card. While the designs provided may be appropriate for many applications and occasions, the limited number of parties having creative input may result in a too-rigid environment that does not offer sufficient options for conveying certain messages.

Thus, there is a need for a graphics design system that offers consumers the capability to create and/or customize graphic designs according to their communications needs. There is also a need for a system where those consumer-created designs can be shared among the population of consumers, thus increasing the creative talent pool for graphic design.

### SUMMARY

Systems and methods are provided for generating a high resolution template in response to user controls provided over a network. An edit to a particular template is received over a network, and a template edit record associated with the particular template is stored in a data store. A preview of the particular template is provided using the network, the preview being an approximation of a high resolution version of the particular template that incorporates the received edit. Additional edits to the particular template are received and stored as additional template edit records. The template edit record and additional template edit records are provided to a high resolution template generator, where the high resolution template generator creates the high resolution version of the particular template based on the template edit record and additional template edit records. The high resolution version of the particular template is stored.

As another example, a system for generating a high resolution template in response to user controls provided over a network may include one or more data processors and a computer-readable medium encoded with instructions for commanding the one or more data processors to execute a method. In the method, an edit to a particular template is received over a network, and a template edit record associated with the particular template is stored in a data store. A preview of the particular template is provided using the network, the preview being an approximation of a high resolution version of the particular template that incorporates the received edit. Additional edits to the particular template are received and stored as additional template edit records. The template edit record and additional template edit records are provided to a high resolution template generator, where the high resolution template generator creates the high resolution version of the particular template based on the template edit record and additional template edit records. The high resolution version of the particular template is stored.

As a further example, a computer-readable medium may be encoded with instructions for commanding one or more data processors to execute a method for generating a high resolution template in response to user controls provided over a network. In the method, an edit to a particular template is received over a network, and a template edit record associated with the particular template is stored in a data store. A preview of the particular template is provided using the network, the preview being an approximation of a high resolution version of the particular template that incorporates the received edit. Additional edits to the particular template are received and stored as additional template edit records. The template edit record and additional template edit records are provided to a high resolution template generator, where the high resolution template generator creates the high resolution version of the particular template based on the template edit record and additional template edit records. The high resolution version of the particular template is stored.

### BRIEF DESCRIPTION OF THE DRAWINGS

FIG. 1 is a block diagram depicting an example high resolution design template generator.

FIG. 2 includes block diagrams depicting the customization and printing of templates.

FIG. 3 is a flow diagram depicting a creation or customization of a template.

FIG. 4 is a flow diagram depicting a second creation or customization of a template process.

FIG. 5 is a block diagram depicting a process for generating a high resolution version of an edited template.

FIG. 6 is a block diagram depicting an example system for generating a high resolution version of a template.

FIG. 7 is a flow diagram depicting a process of generating a high resolution graphic design.

FIGS. 8A, 8B, and 9 depict example graphic designs created using the above described process.

FIGS. 10A, 10B, and 10C depict example systems for use in implementing a constructed response scoring manager.

### DETAILED DESCRIPTION

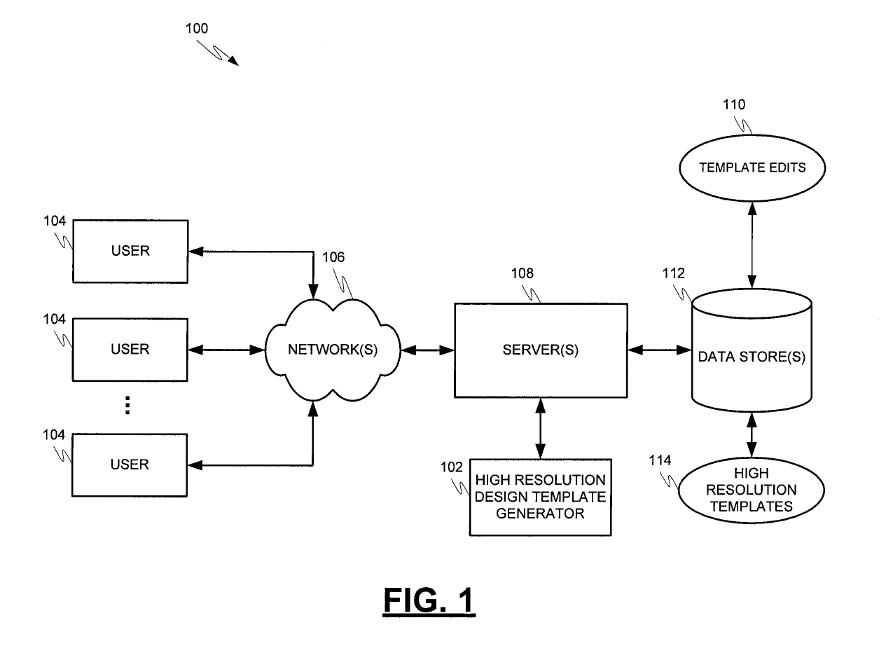

FIG. 1 is a block diagram depicting an example high resolution design template generator. The high resolution design template generator 102 manages the creation and customization of graphic designs and templates by a number of users 104 via one or more networks 106, such as the Internet.

For example, one or more servers 108 that are responsive to the network may provide an interface to the users 104 that enables efficient design and creation of templates. A user may wish to customize such templates to use in a high quality printing project (e.g., greeting cards, invitations, business cards). The high resolution design template generator receives edits to a particular template and stores those template edits 110 in one or more data stores 112. The high resolution design template generator 102 uses those stored template edits 110 to generate a high resolution template 114. The high resolution template 114 is of sufficient detail to enable a printing at a quality level desired by the users 104.

Certain obstacles may present themselves in the implementation of a system such as the system depicted in FIG. 1. For example, the one or more networks 106 may contain certain bottlenecks or other limitations that affect the speed at which data can be exchanged between the high resolution design template generator 102 and a user 104. Additionally, certain software limitations, such as a user's web browser or computer display capabilities may hinder a user's ability to view high resolution images (e.g., layered images that cannot be rendered by a browser with full fidelity or at acceptable speeds, text having certain effects applied such as opacity, blending modes multiply applied, drop shadow, text as a clipping mask, a “Soft Light” blending mode, patterns specifically designed within high resolution design template generator but not the browser). Thus, transmitting a full-size high resolution template 114 to the user 104 through the network for viewing and customizing may be suboptimal because of the large amount of bandwidth necessary to transmit the high resolution template 114 back and forth through the network and because user hardware and software may not be capable of viewing the high resolution template 114 in its high quality form, wasting the bandwidth used to transmit the high resolution version.

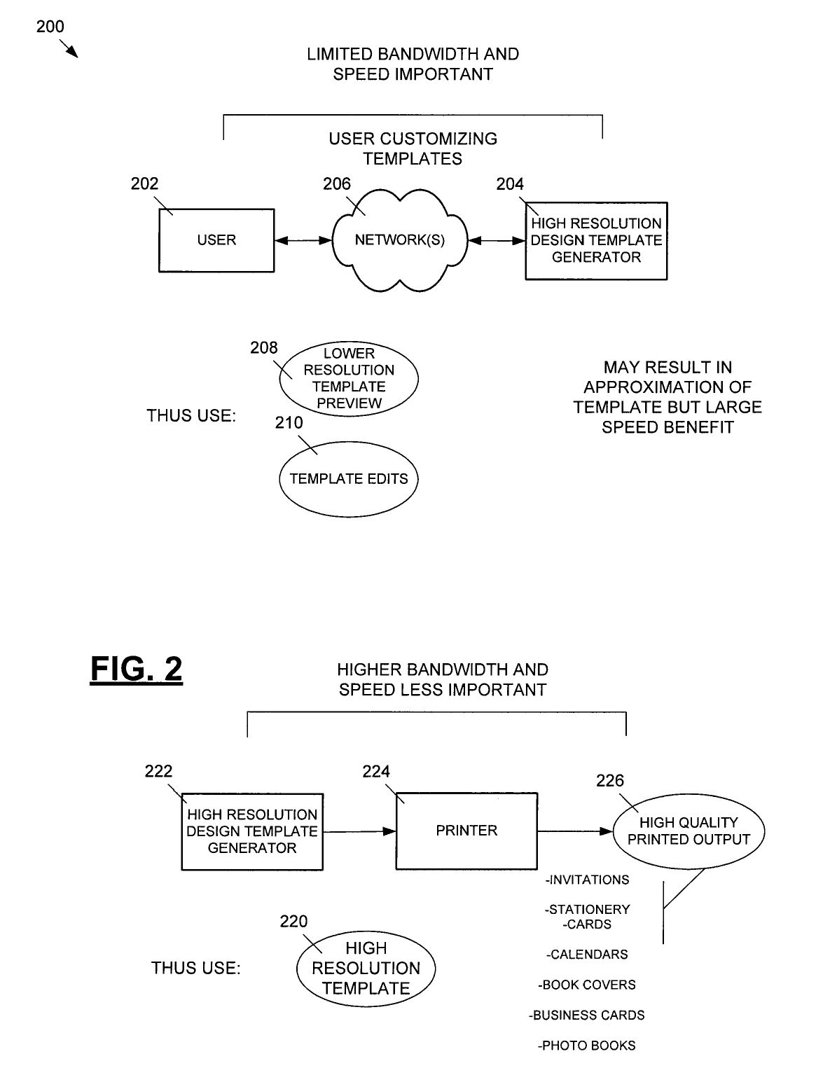

To address these concerns, a high resolution design template generator 102 may utilize preview versions of the high resolution templates 114 during customization interactions with the users 104, while using the high resolution templates 114 for printing. FIG. 2 includes block diagrams depicting the customization and printing of templates. The top diagram depicts communications between a user 202 and a high resolution design template generator 204 through a network 206 in creating or customizing a template. As noted above, such customizations may be performed in a limited bandwidth environment. The efficiency of such communications may also be important to the user 202. If the user 202 is forced to wait while large data transactions are made to and from the high resolution design template generator 204 through the network 206, then the user may become frustrated and abandon the process.

To avoid such user frustrations, the template creation and customization process may be facilitated using smaller sized communications. For example, a user may be provided a preview 208 of a particular template being customized. The preview 208 may be an approximation of a high resolution version of the particular template that incorporates the edits and customizations of the user 202. The user may edit the preview, such as via a customization user interface in a web browser, and the template edits 210 may be provided to the high resolution design template generator 204 via the one or more networks 206. Using the preview version 208 of the high resolution version may result in the user viewing only an approximation of the high resolution version. However, the improved speed and efficiency of template customization may make this a desirable trade.

The bottom diagram in FIG. 2 illustrates a template printing process. Because it is often desirable for the template to be printed at a high quality level, the printing process may utilize a high resolution version of the template 220. Unlike the user customization process, where many customization communications may be made, the printing process should involve a limited number of communications. For example, the high resolution design template generator 222 may transmit the high resolution template 220 to a printer 224. The printer 224 processes the high resolution template 220 to produce a high quality printed output 226, such as invitations, stationery, cards, calendars, book covers, business cards, and photo books.

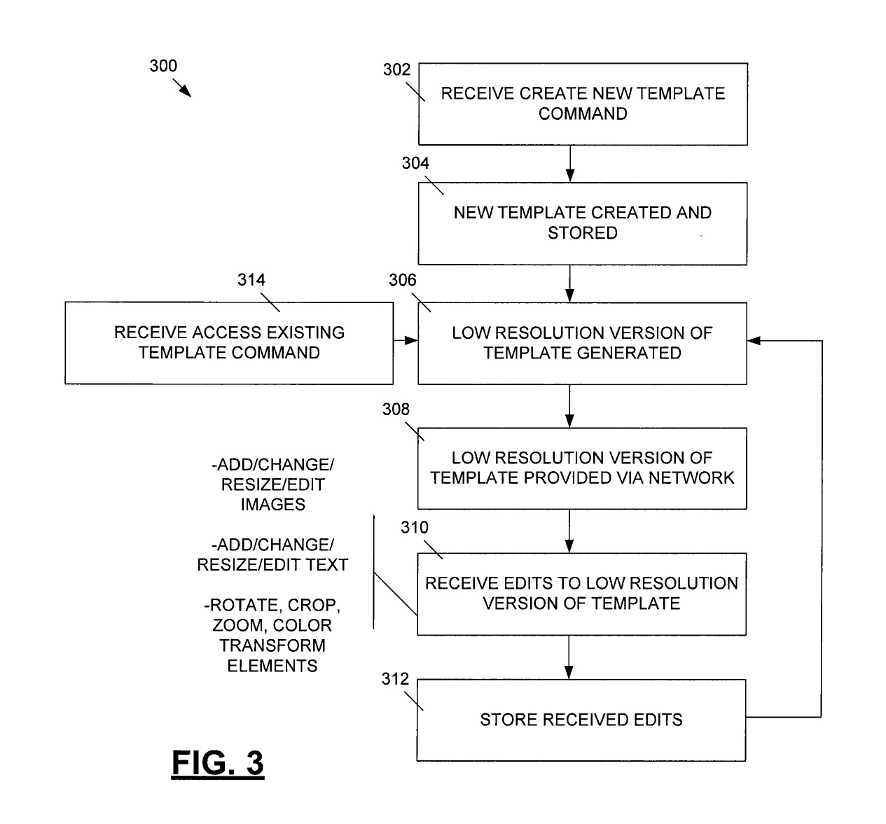

FIG. 3 is a flow diagram depicting a creation or customization of a template. At 302 a command is received to create a new template. A new template is created and stored at 304. For example, the new template may be stored using one or more records in a database. The one or more records may contain parameters of the new template such as title, size, and creator. The one or more records in the database may also contain a number of edits made to the template (e.g., a record in the database identifying a change of the background of the template to blue, a record in the database identifying an addition of an image to the template, a record in the database identifying a resizing and rotation of the image, a record in the database identifying a text addition to the template).

At 306, a low resolution version of the template is generated, and at 308, the low resolution version of the template is provided to a user via a network. Edits to the low resolution version of the template may be received from the user at 310. For example, the user may command that images in the template be added, changed, resized, edited, or deleted. Text in the template preview may be added, changed, resized, edited, or deleted. Commands may also be received for rotating, zooming, cropping and color transforming elements in the template. The received edits are stored at 312, and the process returns to 306, where a revised low resolution version of the template is generated and transmitted to the user via the network at 308.

The process may also begin at 314, where a user may request to access an existing template to edit. The low resolution version of the template is generated at 306 and provided to the user at 308 for editing.

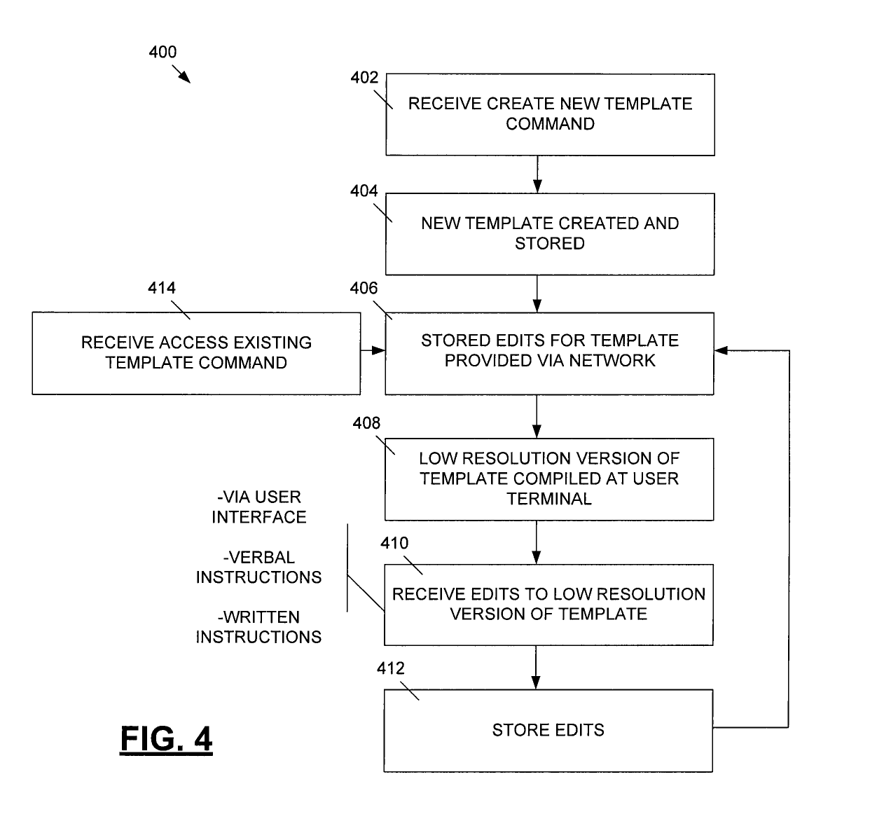

FIG. 4 is a flow diagram depicting a second creation or customization of a template process. At 402 a command is received to create a new template. A new template is created and stored at 404. At 406, stored edits to the template are provided to the user via a network. At 408, a low resolution version of the template is generated at the user terminal. For example, the low resolution version of the template may be generated by an application running on a user terminal or by an applet associated with a web browser on the user terminal using the stored edits transmitted at 406. Edits to the low resolution version of the template may be received from the user at 410. For example, edits could be provided via a user interface. Edits could also be received via verbal or written instructions. The received edits are stored at 412, and the process returns to 406, where the stored edits for the template are accessed and transmitted to the user via the network. The process may also begin at 414, where a user may request to access an existing template to edit. Edits to the template are accessed and provided to the user at 406, and the user terminal generates a low resolution version of the template at 408.

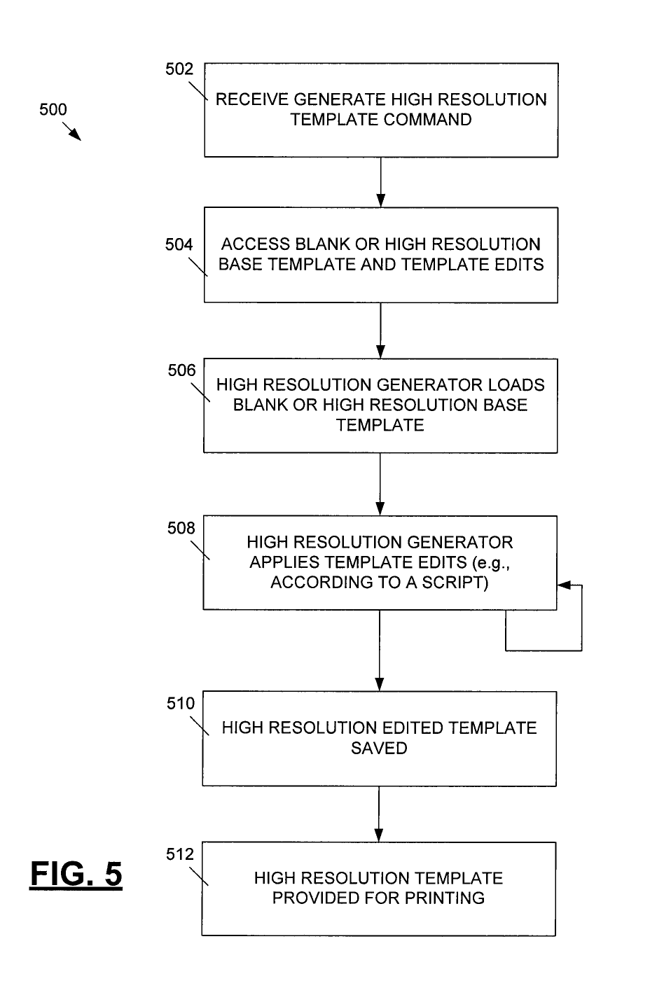

FIG. 5 is a block diagram depicting a process for generating a high resolution version of an edited template. At 502, a command is received to generate a high resolution version of a template. At 504, a blank template or a high resolution base template (e.g., a starter template from which further edits are made) is accessed, and at 506, a high resolution generator loads the blank or high resolution base template. At 508, the high resolution generator applies edits to the template. For example, stored edit records may be accessed and provided to the high resolution generator. The high resolution generator receives those edits and applies those edits to the loaded blank or base template to generate the high resolution version of the template according to the user edits. At 510, the edited high resolution template is saved, and at 512, the high resolution template may be provided for printing.

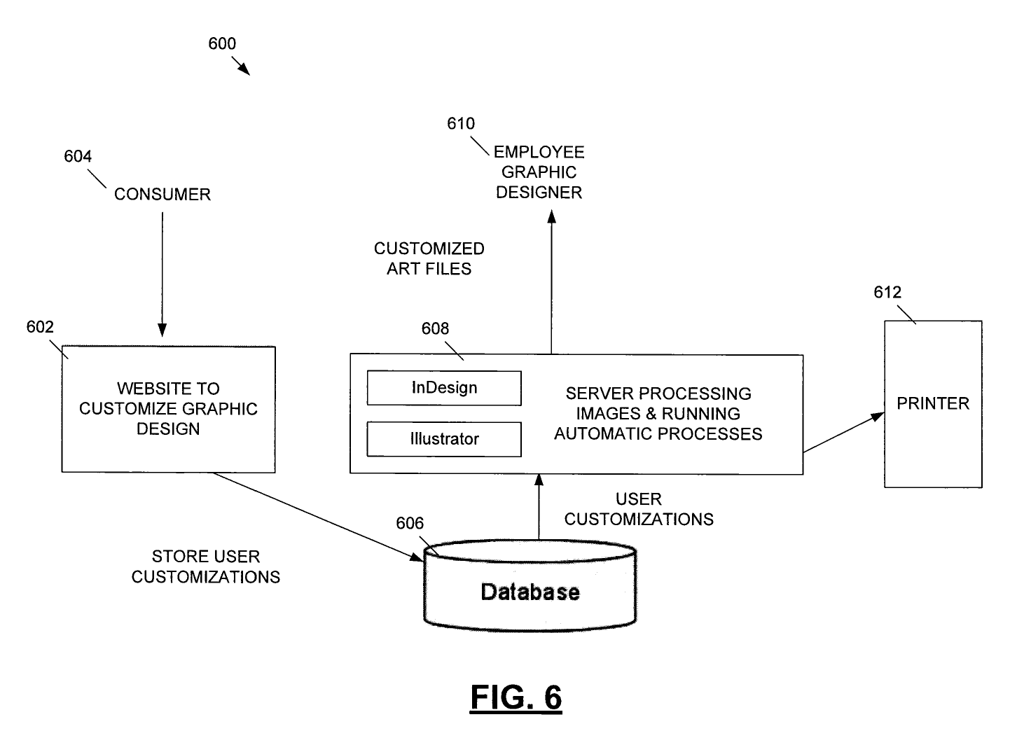

FIG. 6 is a block diagram depicting an example system for generating a high resolution version of a template. The system includes a website at 602. A consumer 604 accesses the website to customize a graphic design. Customizations that the consumer 604 makes are stored in a database 606. When customization is completed, the user customizations are provided to a server 608 for processing images and running automatic processes. The server receives the user customizations and provides the customizations to an application to generate a high resolution version of the graphic design. For example, the user customizations may be provided to an application such as an Adobe InDesign® or an Adobe Illustrator® application. The application may apply the user customizations, such as via a script, to generate the high resolution version of the graphic design. The customized art files in the form of the high resolution version of the graphic design may be provided to an employee graphic designer 610 for quality review. One or more employee reviewers may review the finished design to identify any errors that may have occurred during the customization process at the website 602 or during the generation of the high resolution version of the graphic design at the server 608. The one or more employee reviewers may also make aesthetic suggestions for the graphic design which may be incorporated in the edits or provided to the user for approval. If the one or more employee graphic designers 610 approve the graphic design, then the high resolution graphic design may be provided to a printer 612 for printing.

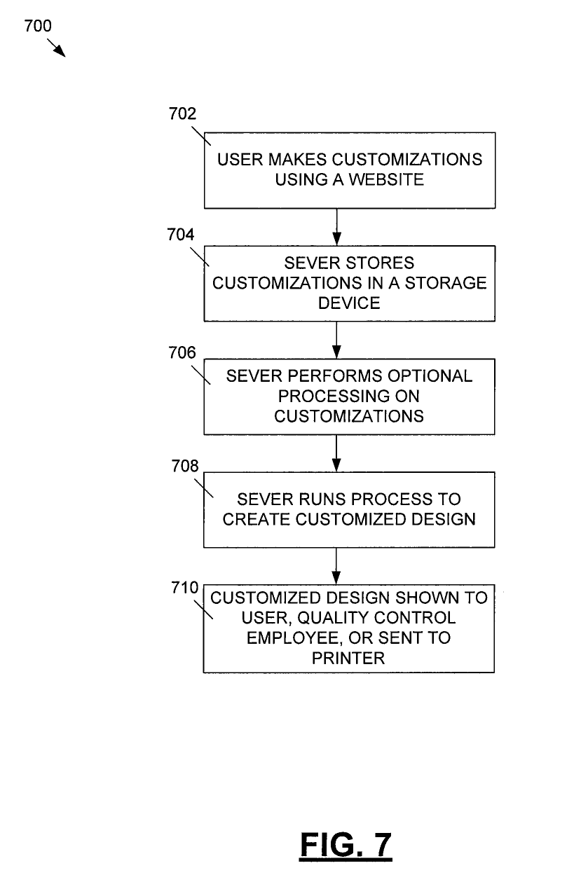

FIG. 7 is a flow diagram depicting a process of generating a high resolution graphic design. At 702, a user makes customizations to a design using a web site. At 704, a server receives those edits and stores the customizations in a storage device, such as a database. A server may optionally perform additional processing on the customizations (e.g., red eye removal in uploaded photographs). At 708, a server runs a process to create a high resolution version of the customized design. At 710, the customized design may be showed to the user, sent to a printer, or reviewed by an employee for quality control.

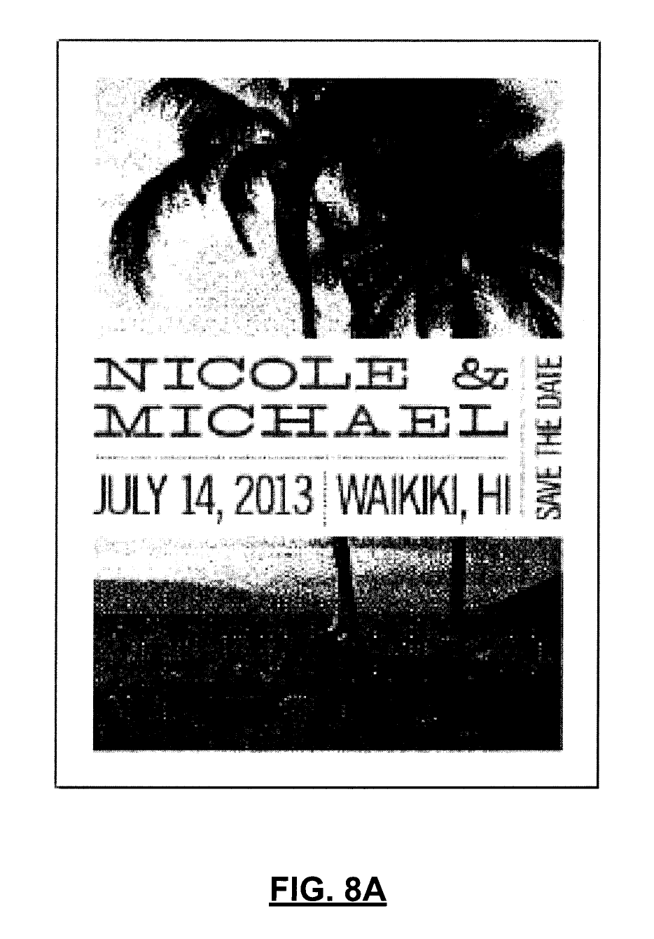

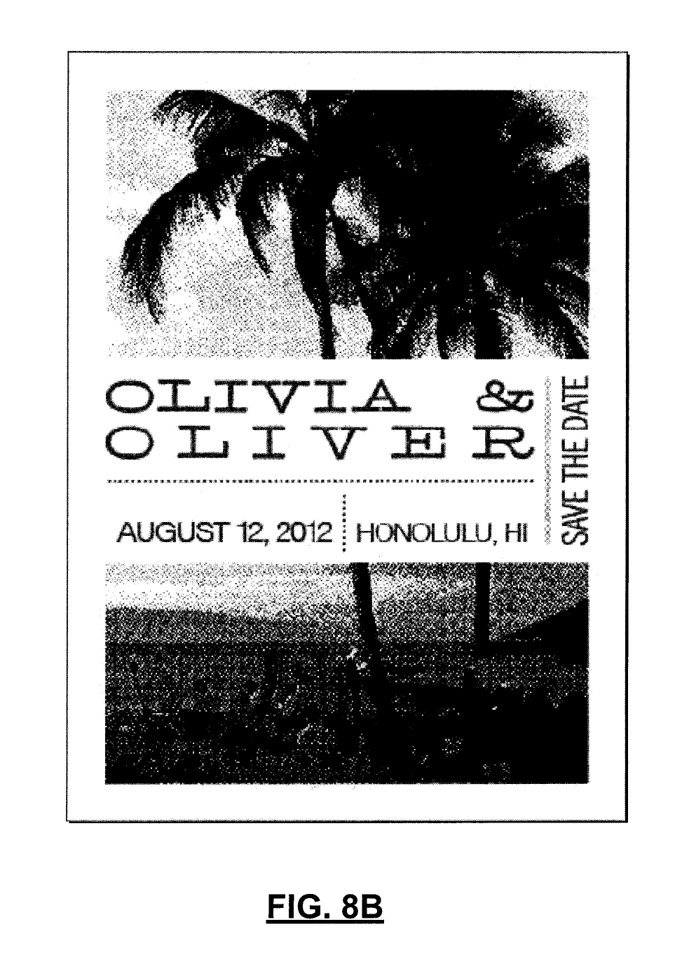

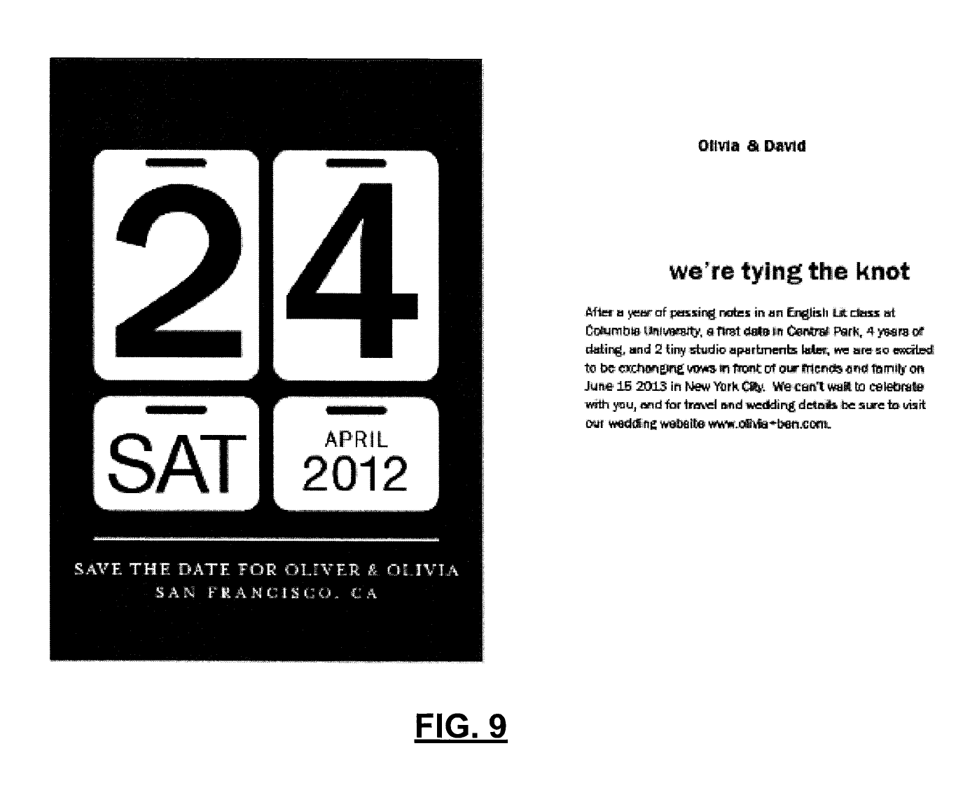

FIGS. 8A, 8B, and 9 depict example graphic designs created using the above described process. FIG. 8A depicts an example template, and FIG. 8B depicts that template having been customized by editing the template text. FIG. 9 depicts another template that can be used for save-the-date wedding notices.

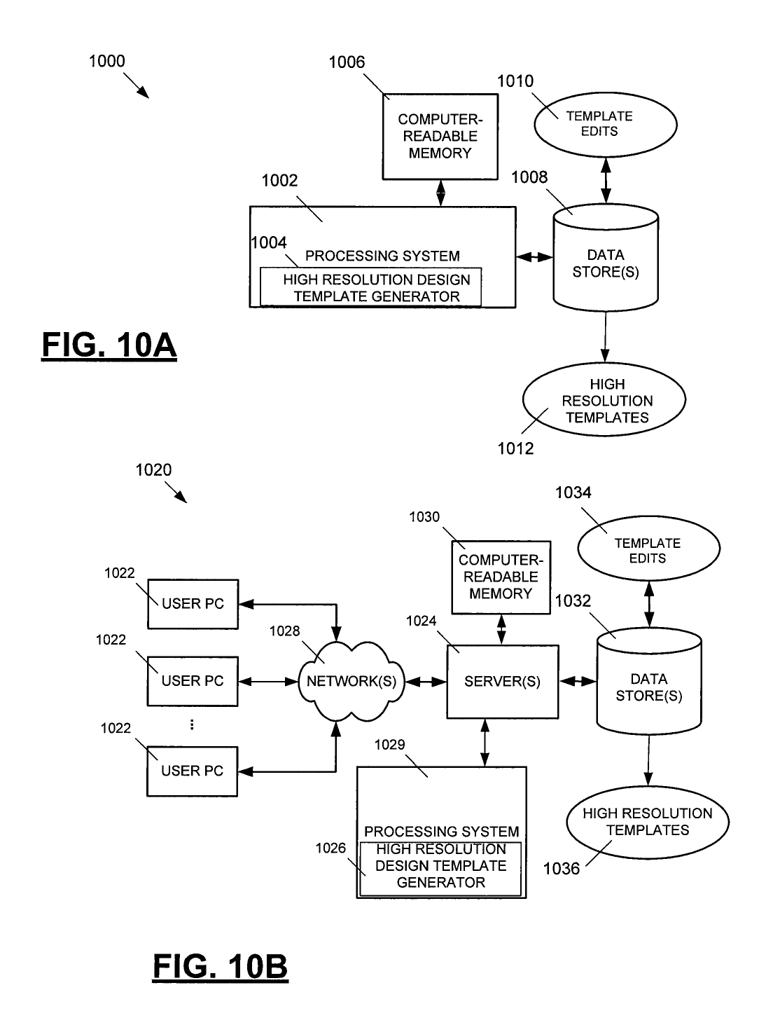

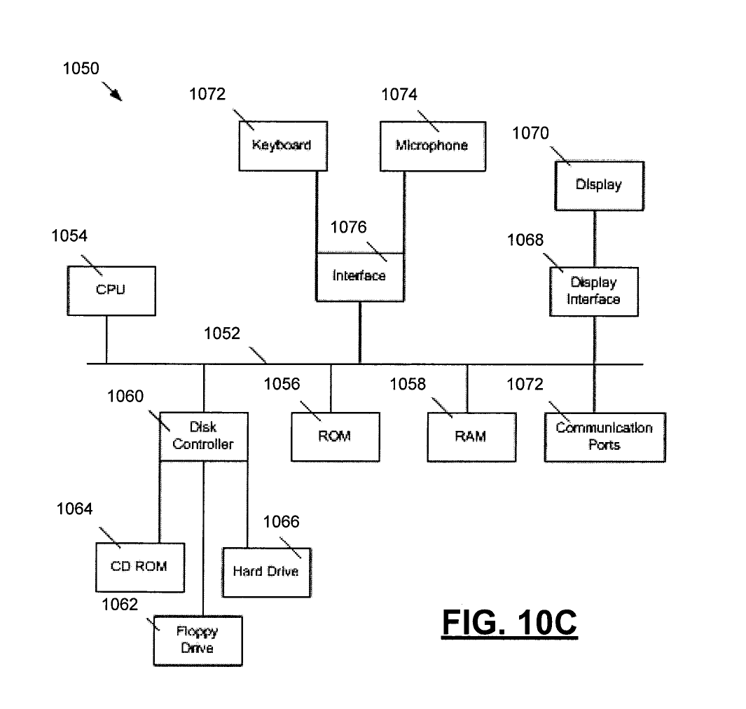

FIGS. 10A, 10B, and 10C depict example systems for use in implementing a high resolution design template generator. For example, FIG. 10A depicts an exemplary system 1000 that includes a stand alone computer architecture where a processing system 1002 (e.g., one or more computer processors) includes a high resolution design template generator 1004 being executed on it. The processing system 1002 has access to a computer-readable memory 1006 in addition to one or more data stores 1008. The one or more data stores 1008 may include template edits 1010 as well as high resolution versions of templates 1012.

FIG. 10B depicts a system 1020 that includes a client server architecture. One or more user PCs 1022 accesses one or more servers 1024 running a high resolution design template generator 1026 on a processing system 1027 via one or more networks 1028. The one or more servers 1024 may access a computer readable memory 1030 as well as one or more data stores 1032. The one or more data stores 1032 may contain template edits 1034 as well as high resolution versions of templates 1036.

FIG. 10C shows a block diagram of exemplary hardware for a standalone computer architecture 1050, such as the architecture depicted in FIG. 10A that may be used to contain and/or implement the program instructions of system embodiments of the present invention. A bus 1052 may serve as the information highway interconnecting the other illustrated components of the hardware. A processing system 1054 labeled CPU (central processing unit) (e.g., one or more computer processors), may perform calculations and logic operations required to execute a program. A processor-readable storage medium, such as read only memory (ROM) 1056 and random access memory (RAM) 1058, may be in communication with the processing system 1054 and may contain one or more programming instructions for performing the method of implementing a high resolution design template generator. Optionally, program instructions may be stored on a computer readable storage medium such as a magnetic disk, optical disk, recordable memory device, flash memory, or other physical storage medium. Computer instructions may also be communicated via a communications signal, or a modulated carrier wave.

A disk controller 1060 interfaces one or more optional disk drives to the system bus 1052. These disk drives may be external or internal floppy disk drives such as 1062, external or internal CD-ROM, CD-R, CD-RW or DVD drives such as 1064, or external or internal hard drives 1066. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 1060, the ROM 1056 and/or the RAM 1058. Preferably, the processor 1054 may access each component as required.

A display interface 1068 may permit information from the bus 1056 to be displayed on a display 1070 in audio, graphic, or alphanumeric format. Communication with external devices may optionally occur using various communication ports 1072.

In addition to the standard computer-type components, the hardware may also include data input devices, such as a keyboard 1072, or other input device 1074, such as a microphone, remote control, pointer, mouse and/or joystick.

As additional examples, for example, the systems and methods may include data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

1. A computer-implemented method of generating a high resolution template in response to user controls provided over a network, comprising:
receiving an edit to a particular template over a network;
storing a template edit record associated with the particular template in a data store;
providing a preview of the particular template using the network, the preview being an approximation of a high resolution version of the particular template that incorporates the received edit, additional edits to the particular template being received and stored as additional template edit records;
providing the template edit record and additional template edit records to a high resolution template generator, the high resolution template generator creating the high resolution version of the particular template based on the template edit record and additional template edit records; and
storing the high resolution version of the particular template.

2. The method of claim 1, further comprising printing the high resolution version of the particular template.

3. The method of claim 1, wherein the preview of the particular template is half size of the high resolution template or smaller.

4. The method of claim 1, wherein providing the preview of the particular template includes generating the preview based on the template edit record and transmitting the preview of the particular template via the network.

5. The method of claim 1, wherein providing the preview of the particular template includes transmitting the template edit record via the network, wherein the preview of the particular template is generated user-side based on the transmitted template edit record.

6. The method of claim 1, wherein the template edit record and additional template edit records are provided to the high resolution template generator using a script.

7. The method of claim 1, wherein the preview is provided for display in a browser.

8. The method of claim 7, wherein the received edit includes layered images that cannot be rendered by a browser with full fidelity.

9. The method of claim 1, wherein the edit is an image insertion, a text insertion, or a rotation, movement, cropping, zooming, or color transformation of an image or text.

10. The method of claim 1, wherein the high resolution version is provided for quality review and printed upon quality review approval.

11. A computer-implemented system for generating a high resolution template in response to user controls provided over a network, the system comprising:
one or more data processors;
one or more computer-readable storage mediums that include software for commanding the one or more data processors to execute steps that include:
receiving an edit to a particular template over a network;
storing a template edit record associated with the particular template in a data store;
providing a preview of the particular template using the network, the preview being an approximation of a high resolution version of the particular template that incorporates the received edit, additional edits to the particular template being received and stored as additional template edit records;
providing the template edit record and additional template edit records to a high resolution template generator, the high resolution template generator creating the high resolution version of the particular template based on the template edit record and additional template edit records; and
storing the high resolution version of the particular template.

12. The system of claim 11, wherein the steps further include printing the high resolution version of the particular template.

13. The system of claim 11, wherein providing the preview of the particular template includes generating the preview based on the template edit record and transmitting the preview of the particular template via the network.

14. The system of claim 11, wherein providing the preview of the particular template includes transmitting the template edit record via the network, wherein the preview of the particular template is generated user-side based on the transmitted template edit record.

15. The system of claim 11, wherein the template edit record and additional template edit records are provided to the high resolution template generator using a script.

16. The system of claim 11, wherein the preview is provided for display in a browser.

17. The system of claim 16, wherein the received edit includes layered images that cannot be rendered by a browser with full fidelity.

18. A computer-readable medium encoded with instructions for commanding one or more data processors to execute a method for of generating a high resolution template in response to user controls provided over a network, the method comprising:
receiving an edit to a particular template over a network;
storing a template edit record associated with the particular template in a data store;
providing a preview of the particular template using the network, the preview being an approximation of a high resolution version of the particular template that incorporates the received edit, additional edits to the particular template being received and stored as additional template edit records;
providing the template edit record and additional template edit records to a high resolution template generator, the high resolution template generator creating the high resolution version of the particular template based on the template edit record and additional template edit records; and
storing the high resolution version of the particular template.
